(19) United States
(12) Patent Application Publication
(10) Pub. No.: US 2024/0157695 A1
(43) Pub. Date: May 16, 2024

(54) LIQUID DISCHARGE APPARATUS AND METHOD OF SETTING ALLOWABLE GAP RANGE

(71) Applicant: Tetsu Morino, Kanagawa (JP)

(72) Inventor: Tetsu Morino, Kanagawa (JP)

(73) Assignee: Ricoh Company, Ltd., Tokyo (JP)

(21) Appl. No.: 18/487,395

(22) Filed: Oct. 16, 2023

(30) Foreign Application Priority Data
Nov. 14, 2022 (JP) 2022-182066

(51) Int. Cl. B41J 2/045; B41J 11/02

(52) U.S. Cl. CPC B41J 2/04501; B41J 11/02; B41J 2203/00

(57) ABSTRACT

A liquid discharge apparatus includes a recording head, a platen, a measuring device, and control circuitry. The recording head discharges liquid droplets. The platen holds a recording medium. The measuring device measures a gap between the recording head and a 5 recording surface of the recording medium held by the platen. The control circuitry causes the recording head to discharge liquid droplets in accordance with print data to perform printing on the recording medium held by the platen, the control circuitry configured to set a range of the gap between the recording head and the recording surface of the recording medium, in which printing is allowed for a type of the recording medium, in accordance with 10 data for specifying the type of the recording medium held by the platen and a measured value of the gap measured by the measuring device.

### CROSS-REFERENCE TO RELATED APPLICATIONS

This patent application is based on and claims priority pursuant to 35 U.S.C. § 119(a) to Japanese Patent Application No. 2022-182066, filed on Nov. 14, 2022, in the Japan Patent Office, the entire disclosure of which is hereby incorporated by reference herein.

### BACKGROUND

### Technical Field

Embodiments of the present disclosure relate to a liquid discharge apparatus and a method of setting an allowable gap range.

### Related Art

Inkjet printers discharge liquid droplets from recording heads to a recording medium to perform printing. Accordingly, if the amount of gaps between the recording heads and the recording surface of the recording medium is not constant, the liquid droplets may not land on the recording surface of the recording medium in a constant manner. As a result, the print quality may be degraded. Accordingly, in inkjet printers, preferably, the amount of gaps between the recording heads and the recording surface of the recording medium is constant.

A technology has been disclosed that the speed at which ink droplets are discharged from recording heads and the drive waveforms applied to the recording heads are selected in accordance with the gaps between recording heads and the recording surface of a recording medium. Another technology has been disclosed in which the gaps between recording heads and the recording surface of a recording medium are detected to automatically adjust the speed at which the recording heads are moved in the main scanning direction and the amount of the gaps between recording heads and the recording surface of the recording medium.

### SUMMARY

In an embodiment of the present disclosure, a liquid discharge apparatus includes a recording head, a platen, a measuring device, and control circuitry. The recording head discharges liquid droplets. The platen holds a recording medium. The measuring device measures a gap between the recording head and a recording surface of the recording medium held by the platen. The control circuitry causes the recording head to discharge liquid droplets in accordance with print data to perform printing on the recording medium held by the platen. The control circuitry sets a range of the gap between the recording head and the recording surface of the recording medium, in which printing is allowed for a type of the recording medium, in accordance with data for specifying the type of the recording medium held by the platen and a measured value of the gap measured by the measuring device.

In another embodiment of the present disclosure, there is provided a method of setting an allowable gap range in a liquid discharge apparatus including a recording head, a platen to hold a recording medium, and control circuitry to cause the recording head to discharge liquid droplets in accordance with print data to perform printing on the recording medium held by the platen. The method includes measuring and setting. The measuring measures a gap between the recording head and a recording surface of the recording medium held by the platen. The setting sets a range of the gap between the recording head and the recording surface of the recording medium held by the platen, in which printing is allowed for a type of the recording medium, in accordance with data for specifying the type of the recording medium and a measured value of the gap measured by the measuring.

### BRIEF DESCRIPTION OF THE DRAWINGS

A more complete appreciation of the disclosure and many of the attendant advantages and features thereof can be readily obtained and understood from the following detailed description with reference to the accompanying drawings, wherein:

FIG. 1 is an external perspective view of a printer according to an embodiment of the present disclosure;

FIG. 2 is a plan view of the printer of FIG. 1;

FIG. 3 is a front view of the printer of FIG. 1;

FIG. 4 is an external perspective view of a printer according to a first embodiment of the present disclosure;

FIG. 5 is an external perspective view of the printer of FIG. 4 from which a platen is removed;

FIG. 6 is a perspective view of the lower surface of a platen, according to an embodiment of the present disclosure;

FIG. 7 is an external perspective view of a platen according to a first embodiment of the present disclosure;

FIG. 8 is an external perspective view of a platen according to the first embodiment of the present disclosure;

FIG. 9 is an external perspective view of a platen according to the first embodiment of the present disclosure;

FIG. 10 is a flowchart of setting a reference allowable-gap amount, according to the first embodiment of the present disclosure;

FIG. 11 is a diagram illustrating a recording medium having irregularities set on a platen, according to an embodiment of the present disclosure;

FIG. 12 is a flow chart of a procedure of setting an allowable-gap amount, according to the first embodiment of the present disclosure;

FIG. 13 is a diagram illustrating how the recording surface of a recording medium is scanned by a gap-measuring sensor, according to an embodiment of the present disclosure;

FIG. 14 is a diagram illustrating how the recording surface of a recording medium is scanned by a gap-measuring sensor, according to an embodiment of the present disclosure;

FIG. 15 is a diagram illustrating how the recording surface of a recording medium is scanned by a gap-measuring sensor, according to an embodiment of the present disclosure;

FIG. 16 is a diagram illustrating how the recording surface of a recording medium is scanned by a gap-measuring sensor, according to an embodiment of the present disclosure;

FIG. 17 is a flow chart of a printing process according to the first embodiment of the present disclosure;

FIG. 18 is a flow chart of a procedure of setting an allowable-gap amount, according to a second embodiment of the present disclosure;

FIG. 19 is a flow chart of a procedure of setting an allowable-gap amount, according to a third embodiment of the present disclosure; and

FIG. 20 is a flow chart of a procedure of setting an allowable gap amount, according to a fourth embodiment of the present disclosure.

The accompanying drawings are intended to depict embodiments of the present disclosure and should not be interpreted to limit the scope thereof. The accompanying drawings are not to be considered as drawn to scale unless explicitly noted. Also, identical or similar reference numerals designate identical or similar components throughout the several views.

### DETAILED DESCRIPTION

In describing embodiments illustrated in the drawings, specific terminology is employed for the sake of clarity. However, the disclosure of this specification is not intended to be limited to the specific terminology so selected and it is to be understood that each specific element includes all technical equivalents that have a similar function, operate in a similar manner, and achieve a similar result.

Referring now to the drawings, embodiments of the present disclosure are described below. As used herein, the singular forms “a,” “an,” and “the” are intended to include the plural forms as well, unless the context clearly indicates otherwise.

Embodiments of the present disclosure are described in detail below with reference to the drawings. Note that numerous additional modifications and variations are possible in light of the above teachings. It is therefore to be understood that within the scope of the appended claims, the embodiments of the present disclosure may be practiced otherwise than as specifically described herein. For example, elements and/or features of different illustrative embodiments may be combined with each other and/or substituted for each other within the scope of this disclosure and appended claims.

In the description of the embodiments of the present disclosure and the drawings, like reference signs denote like or equivalent components, and overlapping descriptions of those components may be simplified or omitted as appropriate. For ease of understanding, the scale of components in the drawings may be different from the actual scale of the components.

### Basic Overall Configuration

First, an overall configuration of a printer as a liquid discharge apparatus according to embodiments of the present disclosure is described below.

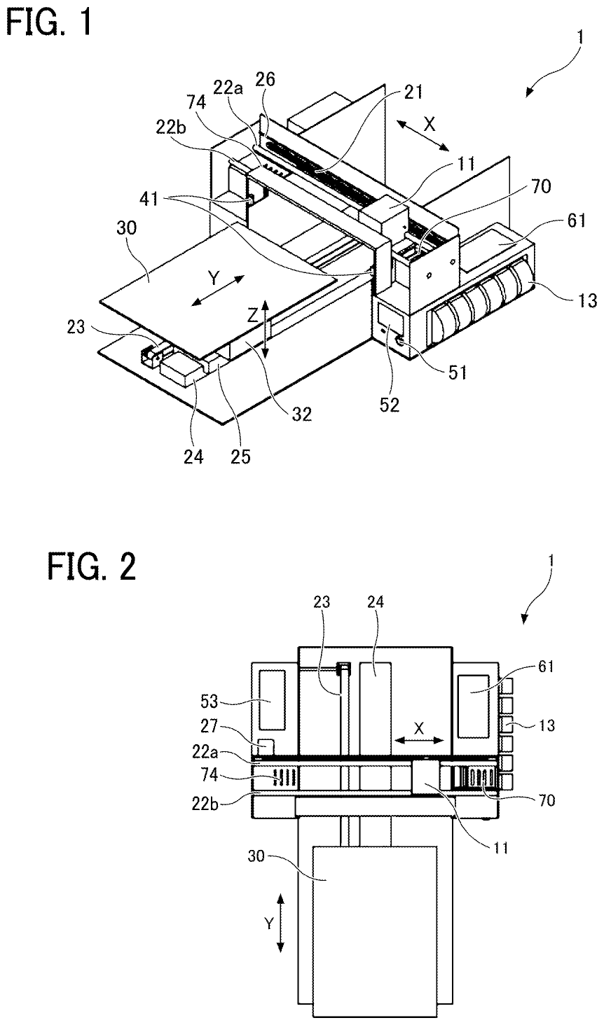

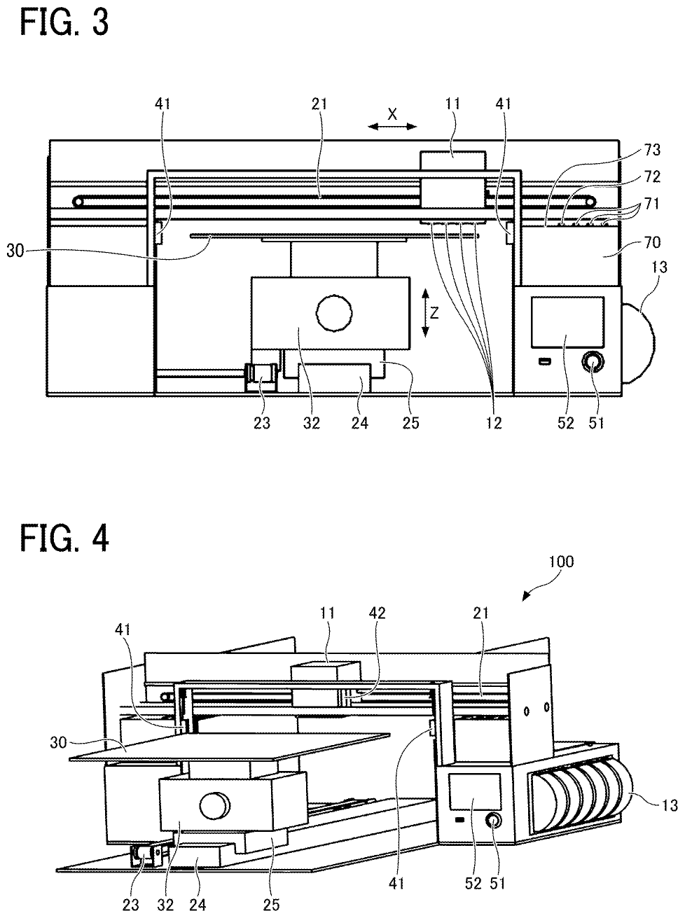

FIG. 1 is an external perspective view of a printer 1 according to an embodiment of the present disclosure. FIG. 2 is a plan view of the printer 1 according to the present embodiment. FIG. 3 is a front view of the printer 1 according to the present embodiment.

As illustrated in FIGS. 1, 2 and 3, the printer 1 includes a carriage 11, a platen 30, and a controller board 61 that serves as control circuitry. The carriage 11 includes four recording heads 12 arranged in a main-scanning direction X (see FIG. 3). Each of the four recording heads 12 has two nozzle rows in a sub-scanning direction Y, in which nozzles for discharging ink are arranged. The printer 1 includes head tanks to temporarily store ink to be discharged, immediately above the recording heads 12 in the carriage 11. The printer 1 further includes ink-supply tubes, ink-supply pumps, and ink cartridges 13. The head tanks are connected to the respective ink cartridges 13 via the respective ink supply tubes and the respective ink supply pumps. The printer 1 operates the ink supply pumps as needed to supply ink from the ink cartridges 13 to the head tanks.

The printer 1 includes a pair of guide rods 22a and 22b (see FIG. 1) extending in the main-scanning direction X and a timing belt 21 driven along the guide rods 22a and 22b. The carriage 11 on which the recording heads 12 are mounted is held by the guide rods 22a and 22b. A main-scanning motor 27 drives the timing belt 21 to cause the carriage 11 to reciprocate in the main-scanning direction X along the guide rods 22a and 22b.

The printer 1 includes an encoder sheet 26 (see FIG. 1) on which slits are periodically formed or printed in the main-scanning direction X to detect the position of the carriage 11. The carriage 11 includes a reading sensor that reads the slits of the encoder sheet 26. The carriage 11 discharges ink droplets as liquid droplets from the recording heads 12 under the control of the controller board 61 while reading the slits of the encoder sheet 26 with the reading sensor at discharge positions when the carriage 11 reads the slits. By so doing, the carriage 11 performs printing to form an image.

The printer 1 includes a platen lifting mechanism 32. The platen 30, on which a recording medium to be printed is placed, is mounted on the platen lifting mechanism 32, and the position of the platen 30 is adjustable in a vertical direction indicated by arrow Z. The direction indicated by arrow Z may also be referred to simply as the Z direction in the following description. The printer 1 includes a guide rail 24 extending in the sub-scanning direction Y perpendicular to the main-scanning direction X, a slider 25 movably mounted on the guide rail 24, and a timing belt 23 driven along the guide rail 24. The platen lifting mechanism 32 is mounted on the slider 25. The timing belt 23 is driven by a driving mechanism that moves in the sub-scanning direction Y under the control of the controller board 61. By so doing, the slider 25 and the platen lifting mechanism 32 are movable in the sub-scanning direction Y. Accordingly, the platen 30 also reciprocates in the sub-scanning direction Y

The controller board 61 processes the input signals of, for example, sensors in accordance with the software installed in the controller board 61 to control the operations and outputs of, for example, motors and solenoids. The controller board 61 also performs print control of print data transmitted from a data processing apparatus connected to the printer 1 and reads out print data recorded in an external storage medium such as a universal serial bus (USB) memory or the controller board 61 to perform print control processing.

The printer 1 includes a maintenance unit 70 to maintain and recover the function of the recording heads 12, on a right end of the printer 1 in the main-scanning direction X in FIG. 3. The maintenance unit 70 includes caps to cover nozzle surfaces of the recording heads 12 on which ink discharge ports, i.e., nozzles, are disposed. The caps protect portions of the recording heads 12 exposed to the ink from being dried when the printer 1 is not operated, i.e., when printer 1 does not print. Examples of the caps include moisture-retention caps 71 and a suction cap 72. The moisture-retention caps 71 have the function of covering the nozzle surfaces of the recording heads 12 to protect the nozzle surfaces from drying. In addition to the function of the moisture-retention caps 71, the suction cap 72 is connected to a suction pump and sucks, for example, thickened ink from the recording heads 12 to recover the recording heads 12 to a favorable condition. The ink sucked by the suction pump is fed via a waste liquid tube inside the printer 1 and via a waste liquid tube outside the printer 1 connected to a port on the rear side of the printer 1 to be discharged to a waste liquid bottle. The maintenance unit 70 includes a wiper 73 for cleaning excess ink remaining on the nozzle surfaces from which ink has been sucked, to recover the condition of the nozzles of the recording heads 12 (see FIG. 3). After the ink remaining on the recording heads 12 has been sucked by the suction cap 72, the wiper 73 wipes the nozzle surfaces of the recording heads 12 to scrape off excess ink. Accordingly, a normal meniscus is formed in each of the nozzles of the recording heads 12.

The printer 1 includes a left-dummy discharge receiver 74 on a left end of the printer 1 in the main-scanning direction X in FIG. 2. The left-dummy discharge receiver 74 15 discards and discharges the ink that has been dried and the viscosity of which has been increased due to contact with air during printing. Ink to be discarded is discharged to the left-dummy discharge receiver 74 at an appropriate timing in response to an instruction from the controller board 61.

The printer 1 includes a pair of height sensors 41 corresponding to both sides of the recording medium in the main-scanning direction X above an area through which the recording medium placed on the platen 30 passes by the movement of the platen 30. Each of the pair of height sensors 41 includes, for example, a light emitter and a light receiver, and detects the height of the recording medium placed on the platen 30 based on the amount of light received by the light receiver that receives the light output from the light emitter. The printer 1 further includes a power supply unit 53 for driving the printer 1, a power button 51, and an operation panel 52. The operation panel 52 includes a liquid crystal display and a touch panel. Operations of the printer 1 can be performed through the operation panel 52 and information about the operations is displayed on the operation panel 52.

When printing is performed on a T-shirt that serves as a recording medium by the printer 1 as described above, the printing is performed in the following procedure.

First, a T-shirt is set on the platen 30. Subsequently, the operation panel 52 is operated to move the slider 25, to cause the platen 30 to be fully retracted to the rear side of the printer 1.

When the platen 30 is retracted to the rear side of the printer 1, the pair of height sensors 41 detects whether the T-shirt on the platen 30 interferes with the recording heads 12. When the pair of height sensors 41 detects that the T-shirt interferes with the recording heads 12, the retraction of the platen 30 is stopped at the time, or the platen 30 is returned to a position on the front side of the printer 1 at which the T-shirt is set. Alternatively, when the T-shirt does not interfere with the recording heads 12 and the retraction of the platen 30 to the rear side of the printer 1 is completed without any trouble, the printer 1 is in a standby mode to receive print data.

In the standby mode to receive print data, when the printer 1 receives print data transmitted from a data processing apparatus such as a personal computer connected to the printer 1, the printer 1 starts a printing operation according to the received print data under the control of the controller board 61. Alternatively, when print data is stored in the controller board 61 in advance, selecting the print data on the operation panel 52 allows the printing operation to be started.

When the printing operation is started, first, the slider 25 is moved to move the platen 30 to the rear side of the printer 1 at which the printing is started. Then, under the control of the controller board 61, ink is discharged from the recording heads 12 in accordance with the print data while the carriage 11 moves by one scan in the main-scanning direction X. By so doing, printing of one line is performed.

When printing of one line is completed, the slider 25 is moved to move the platen 30 by one line in the sub-scanning direction Y toward the front side of the printer 1 to perform line feed processing. By so doing, the T-shirt is moved to the next printing position. When the movement of the slider 25 is completed, ink is discharged from the recording heads 12 while the carriage 11 is moved by one scan in the main-scanning direction X in a similar manner as described above. By so doing, the printing of one line is performed.

The movement of the carriage 11 for one scan, the discharge of ink from the recording heads 12 when the carriage 11 is moved for one scan, and the subsequent movement of the slider 25 are repeated. By so doing, printing is performed on a desired area. When the printing is completed, the platen 30 is moved to the front side of the printer 1 to complete the printing.

When a recording medium 2 having irregularities, such as a T-shirt, is set on the platen 30, the height of the recording surface of the recording medium 2 from the surface of the platen 30 varies depending on the irregularities of the recording medium 2. Accordingly, there may be areas in which the gaps between the recording heads 12 and the recording surface of the recording medium 2 are different from each other.

To deal with such a condition, for example, it is conceivable to adopt the configuration of determining whether the gaps between recording heads and a recording medium are in an appropriate range. In such a case, as described above, there may be areas in which the gaps between the recording heads and the recording surface of the recording medium 2 are different from each other. For this reason, if a reference value for making the above-described determination is set based on the recording medium 2 having irregularities, the following failure may occur. For example, when printing is performed on a recording medium having a flat surface, it may be determined that the gaps between the recording heads and the recording surface of the recording medium are within an appropriate range, even if the gaps between the recording heads and the recording surface of the recording medium are at the maximum gap of the reference value. If printing is performed on a recording medium having a flat surface in such a condition as described above, ink mist is more likely to be generated and the landing positions of ink droplets are more likely to be displaced compared with the case in which the gaps between the recording heads and the recording surface of the recording medium are small.

A liquid discharge apparatus according to embodiments of the present disclosure based on the above-described printer 1 is described below. In the following description, the gaps between the recording heads 12 and the recording surface of a recording medium refer to the gaps between the nozzle surfaces of the recording heads 12 and the recording surface of the recording medium.

### First Embodiment

### Overall Configuration

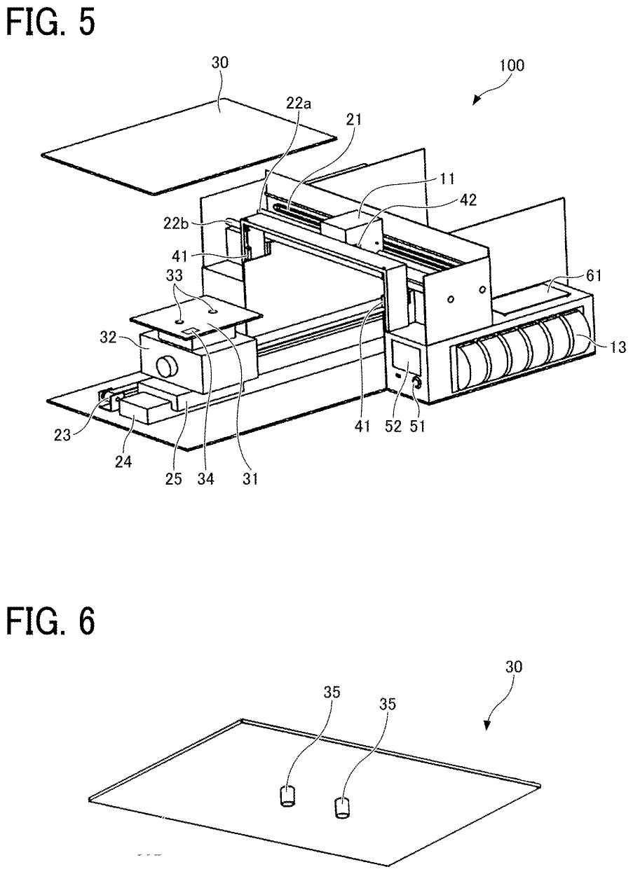

FIG. 4 is an external perspective view of a printer 100 according to a first embodiment of the present disclosure. FIG. 5 is an external perspective view of the printer 100 from which the platen 30 is removed, according to the first embodiment. FIG. 6 is a perspective view of the lower surface of the platen 30, according to the first embodiment.

As illustrated in FIGS. 4 and 5, the liquid discharge apparatus according to the present embodiment is a printer 100 that further includes a gap-measuring sensor 42 and an identification (ID) chip reader 34 in addition to components illustrated in FIGS. 1, 2, and 3.

The gap-measuring sensor 42 serves as a measuring device according to embodiments of the present disclosure. The gap-measuring sensor 42 is mounted on the carriage 11. The gap-measuring sensor 42 scans a recording medium set on the platen 30 as the carriage 11 moves to measure the gaps between the recording heads 12 mounted on the carriage 11 and the recording surface of the recording medium held on the platen 30. The gap-measuring sensor 42 may, for example, irradiate the recording medium with light to measure the gaps based on the amount of light reflected by the recording surface of the recording medium, to measure the gaps in a non-contact manner. In such a case, the gap-measuring sensor 42 does not contact the recording medium. Accordingly, the surface of the recording medium is not rubbed, which is favorable.

The height of the recording medium may be measured as a step to measure the gaps between the recording heads 12 and the recording surface of the recording medium. For example, after the height of the recording medium is measured, the gaps between the platen 30 and the recording surface of the recording medium may be measured based on a difference between the measured height of the recording medium and a preset height position of the recording heads 12. The height of the recording medium may be measured by a height sensor disposed in a direction orthogonal to the height of the recording medium, or may be measured by a sensor disposed in parallel to the head surfaces, or on the head surfaces of the recording heads 12, facing the recording medium.

The printer 100 includes a platen setter 31 on the platen lifting mechanism 32. Types of the platens corresponding to various types of recording media such as a T-shirt, a tote bag, a hat, and shoes can be set onto the platen setter 31, to perform printing on such recording media. The platen setter 31 has a flat plate shape and includes two platen setting holes 33 on the surface of the platen setter 31 on which the recording medium is set.

As illustrated in FIG. 6, the platen 30 includes two cylindrical protrusions 35 on the lower surface of the platen 30. When the protrusions 35 are inserted into the respective platen setting holes 33 of the platen setter 31, the position of the platen 30 with respect to the printer 100 is determined and the platen 30 is set in the printer 100.

The platen setter 31 includes an identification (ID) chip reader 34 on the surface of the platen setter 31 on which the recording medium is set. The ID chip reader 34 serves as a platen sensor according to embodiments of the present disclosure. The platen 30 is prepared for various kinds of recording medium to be set on the platen 30, and various types of platens are available. The platen 30 includes an ID chip such that the type of platen is identified. A platen ID which is data indicating the type of the platen 30 is written in the ID chip. When the platen 30 is set on the platen setter 31, the ID chip mounted on the platen 30 contacts the ID chip reader 34, and the platen ID written in the ID chip is read. The controller board 61 stores the data on the types of the platen 30 in association with the platen IDs. Accordingly, the controller board 61 determines the type of the platen 30 set on the platen setter 31.

### Examples of Platen

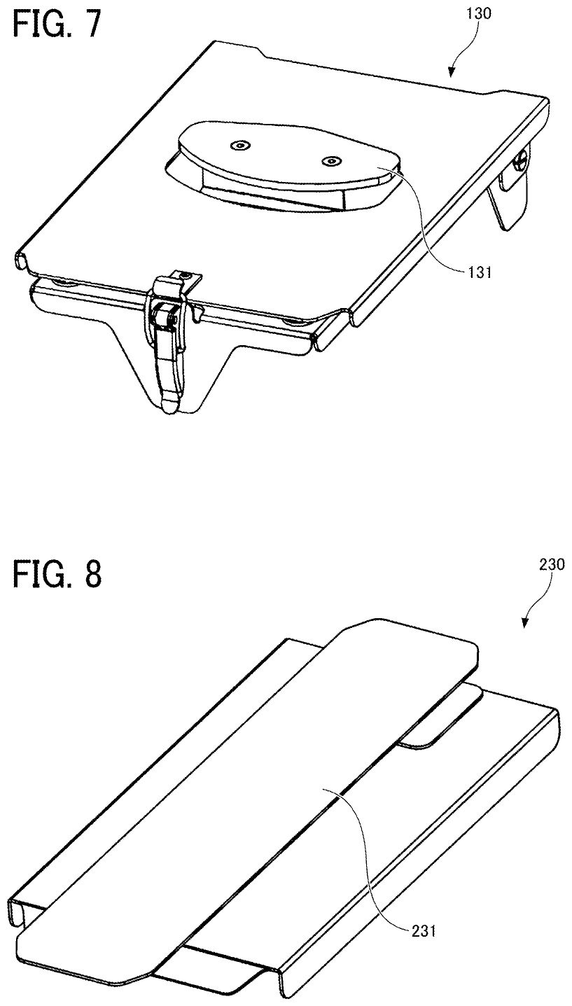

FIGS. 7, 8, and 9 are external perspective views of a platen 130, a platen 230, and a platen 330, respectively, employed in the first embodiment of the present disclosure.

In the printer 100 illustrated in FIGS. 4 and 5, the platen 130 illustrated in FIG. 7 can be set on the platen setter 31. The platen 130 includes a hat setter 131 on the surface of the platen 130. Setting a hat on the hat setter 131 allows printing to be performed on the hat by the printer 100.

In the printer 100 illustrated in FIGS. 4 and 5, the platen 230 illustrated in FIG. 8 can be set on the platen setter 31. The platen 230 includes a sleeve setter 231 on the surface of the platen 230. Setting a sleeve of a shirt on the sleeve setter 231 allows printing to be performed on the sleeve of the shirt by the printer 100.

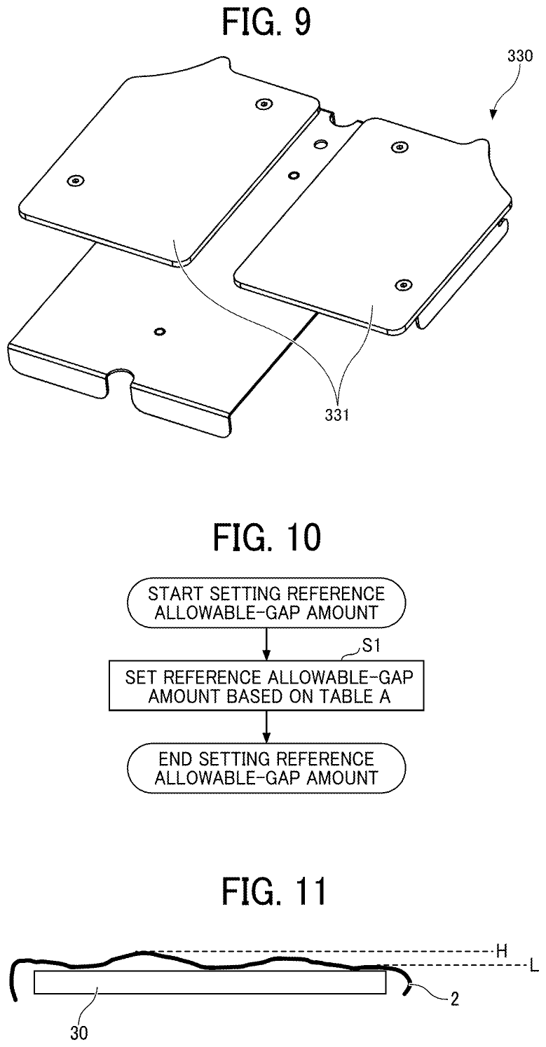

In the printer 100 illustrated in FIGS. 4 and 5, the platen 330 illustrated in FIG. 9 can be set on the platen setter 31. The platen 330 includes a pair of shoe setters 331 on the surface of the platen 330. Setting a shoe on each of the pair of shoe setters 331 allows printing to be performed on the shoes by the printer 100.

As described above, different types of platens to be set on the platen setter 31 are prepared in accordance with the types of recording medium on which printing is performed by the printer 100. The controller board 61 can specify the type of recording medium based on the data indicating the type of platen.

### Setting of Allowable-Gap Amount

FIG. 10 is a flowchart of setting a reference allowable-gap amount in the first embodiment of the present disclosure. FIG. 11 is a diagram illustrating a recording medium having irregularities set on the platen 30, according to the present embodiment.

As described above, when the recording medium 2 having irregularities such as a T-shirt is set on the platen 30, there are areas in which the gaps between the recording heads 12 and the recording surface of the recording medium 2 are different from each other.

Accordingly, a gap amount that allows printing between the recording heads 12 and the recording surface of the recording medium 2 is set for each type of recording medium 2.

As indicated in Table 1, a gap amount is set in which printing is allowed between the recording heads 12 and the recording surface of the recording medium 2 as the reference allowable-gap amount for each type of the platens employed in the present embodiment. Further, an allowable-gap additional amount that is used when an allowable-gap amount to be described below is set. The allowable-gap additional amount may be set in advance at the time of manufacture or by the user via the operation panel 52 to allow printing to be performed for each type of platen employed in the present embodiment, as long as a slight decrease in printing accuracy is allowable. The data indicated in Table 1 is stored as a data table in a storage unit or memory of the controller board 61.

### Table 1

The controller board 61 sets the reference allowable-gap amount in accordance with the type of the platen set in the printer 100 based on the data indicated in Table 1 (step S1).

As illustrated in FIG. 11, the reference allowable-gap amount is a numerical value indicating a range up to an upper limit H on a surface of the printing area, i.e., a portion of the recording surface of the recording medium 2 in the Z direction upward from the recording surface, when a lower limit L, which is a portion of the recording surface of the recording medium 2, farthest from the nozzle surfaces of the recording heads 12, is set to 0. In other words, the gap amount between the recording heads 12 and the recording surface of the recording medium 2 refers to a range of the gaps between the recording heads 12 and the recording surface of the recording medium 2. For example, in Table 1, the printing area of a standard platen is set to 0 to 2 mm in the Z direction as a gap amount in which printing is allowable. As illustrated in FIG. 11, the gap amount from the nozzle surfaces of the recording heads 12 to the recording surface of the recording medium 2 depends on, for example, how the recording medium 2 is set on the platen 30 and the shape of the recording medium 2 itself. For example, when the recording medium 2 is set on the platen 30 with the recording medium 2 wrinkled, the recording medium 2 does not closely contact the platen 30 and the recording surface of the recording medium 2 may not be flat.

In the present embodiment, the gap amount that is the range of gaps in which printing is allowed is set using not only the reference allowable-gap amount indicated in Table 1 but also the gaps between the recording surface of the recording medium 2 set on the platen 30 and the recording heads 12.

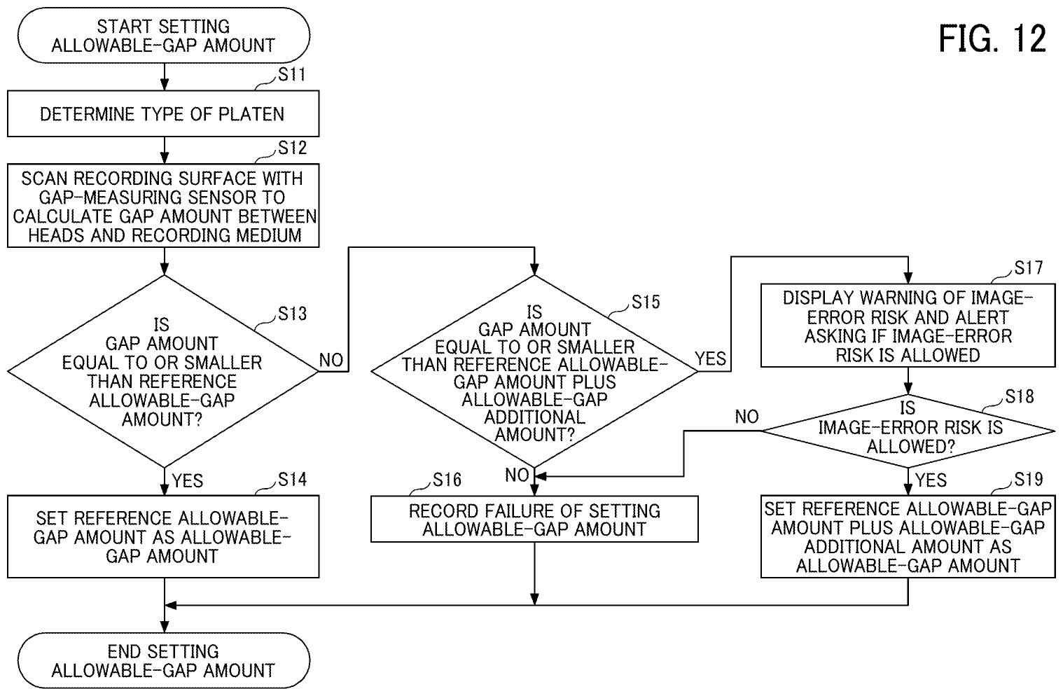

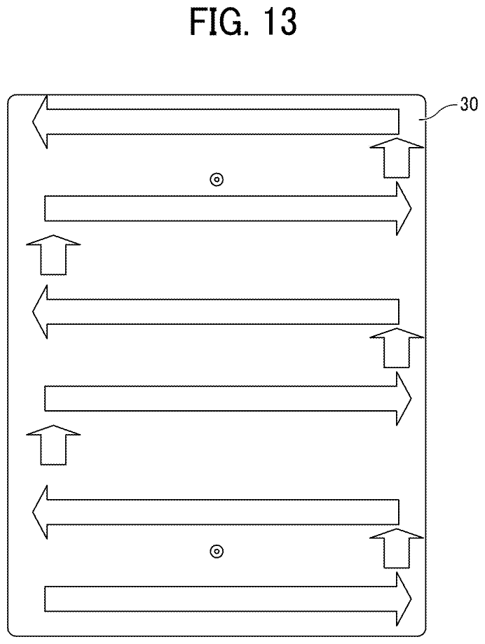

FIG. 12 is a flowchart of a procedure for setting the allowable gap, according to the first embodiment of the present disclosure.

First, when the platen 30 is set on the platen setter 31, the controller board 61 determines the type of the platen 30 (step S11). As described above, when the platen 30 is set on the platen setter 31, the ID chip mounted on the platen contacts the ID chip reader 34. Accordingly, the platen ID written on the ID chip is read. Thus, the controller board 61 determines the type of the platen set on the platen setter 31. Such a configuration in which the platen ID written in the ID chip mounted on the platen 30 is read to determine the type of the platen 30 as described above can save time and labor such as manually inputting the type of the platen 30. The method of determining the type of the platen 30 is not limited to the above-described method. For example, the type of the platen 30 may be determined based on data input manually via the operation panel 52, or data indicating the type of the platen 30 may be included in print data. Alternatively, the gap-measuring sensor 42 is moved in the main-scanning direction X and the sub-scanning direction Y to scan and measure the shape of the platen 30 to compare the shape of the platen 30 with the shapes of the platen 30 stored in the controller board 61 in advance. By so doing, the type of the platen 30 may be determined.

TABLE 1

| | Type of platen | | | |
|---|---|---|---|---|
| | Standard | Platen | Platen | Platen |
| | Platen | for hat | for sleeves | for shoes |
| Reference allowable-gap | 2 | 3 | 2 | 3 |
| amount (mm) | | | | |
| Allowable-gap amount | 1 | 2 | 1 | 2 |
| (mm) | | | | |

Subsequently, when the recording medium 2 is set on the platen 30, the gap-measuring sensor 42 scans the recording surface of the recording medium 2 to measure the gaps between the recording heads 12 and the recording surface of the recording medium 2. Accordingly, the gap amount is calculated (step S12). The gap amount can be calculated from the gaps between the recording heads 12 and an area of the recording surface of the recording medium 2 having a minimum height and the gaps between the recording heads 12 and an area of the recording surface of the recording medium 2 having a maximum height. The gap-measuring sensor 42 scans under the control of the controller board 61. When the gap amount is calculated, preferably a minimum distance (for example, 0.5 mm) between the recording heads 12 and the recording surface of the recording medium 2 is added to the gap amount. By so doing, printing failure due to friction between the recording heads 12 and the recording surface of the recording medium 2 can be avoided.

FIGS. 13, 14, 15, and 16 are diagrams illustrating how the recording surface of the recording medium 2 is scanned by the gap-measuring sensor 42, according to the present embodiment.

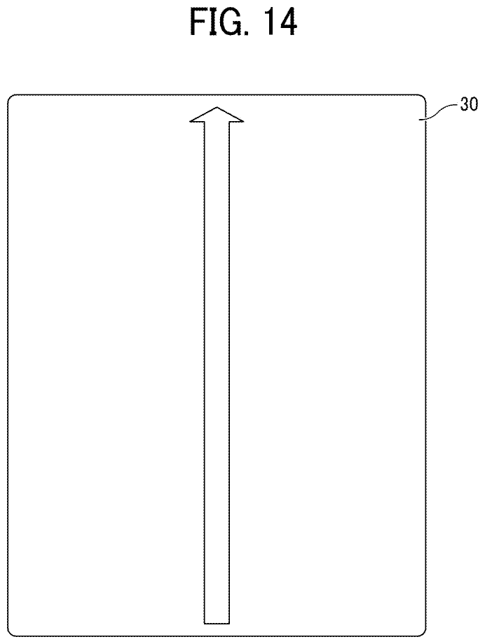

The gap-measuring sensor 42 moves above the printing area of the recording medium 2 in the main-scanning direction X and the sub-scanning direction Y to measure the gaps between the recording heads 12 and the recording surface of the recording medium 2. At this time, if the type of platen determined in step S11 is the standard platen, the gap-measuring sensor 42 preferably scans substantially the entire printing area of the recording medium 2 as indicated by arrows in FIG. 13. Specifically, preferably the gap-measuring sensor 42 scans substantially the entire printing area of the recording medium 2 such that the gap-measuring sensor 42 moves slightly in the sub-scanning direction Y after scanning in the main-scanning direction X, scans in the main-scanning direction X, and then moves again in the sub-scanning direction Y. For the sake of simplifying the scanning operation and reducing the time for the scanning operation, the gap-measuring sensor 42 may be moved linearly only in the main-scanning direction X or in the sub-scanning direction Y, as illustrated in FIG. 14. As described above, the gap-measuring sensor 42 scans the platen 30 along designated routes to measure the gaps between the recording heads 12 and the recording surface of the recording medium 2 held on the platen 30. Such a configuration as described above allows the printer 1 to efficiently measure the gaps between the recording heads 12 and the recording surface of the recording medium 2 held by the platen 30. When the gap-measuring sensor 42 scans in the main-scanning direction X and the sub-scanning direction Y, the pair of height sensors 41 may detect whether the recording medium 2 on the platen 30 interferes with the recording heads 12. Such a configuration as described above allows the total processing time of the printer 100 to be reduced.

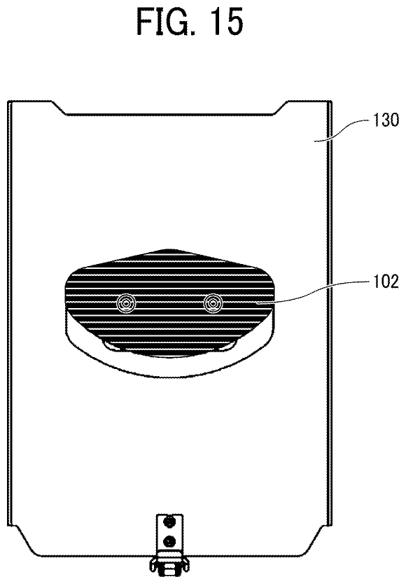

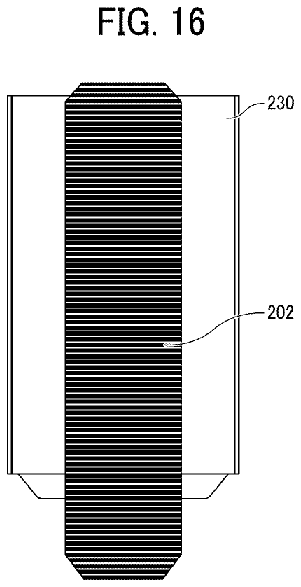

As for the scanning range of the gap-measuring sensor 42, for example, if the type of platen determined in step S11 is the platen 130 for hat as illustrated in FIG. 7, the gap-measuring sensor 42 may scan only an area in which a hat 102 is set, as illustrated in an area with stripes in FIG. 15. For example, if the type of platen determined in step S11 is the platen 230 for sleeves as illustrated in FIG. 8, the gap-measuring sensor 42 may scan only an area in which a sleeve 202 is set as illustrated in an area with stripes in FIG. 16. As described above, the gap-measuring sensor 42 scans a recording medium set on a platen in accordance with the type of the recording medium to measure the gaps between the recording heads 12 and the recording surface of the recording medium held by the platen. Such a configuration as described above allows the gaps between the recording heads 12 and the recording surface of the recording medium held by the platen, to be efficiently measured.

The above-described scanning routes and the scanning ranges of the gap-measuring sensor 42 may be selected via the operation panel 52 or may be automatically set according to the type of platen. Alternatively, only an area of the recording medium 2 to be printed may be extracted from the print data and scanned.

When the gaps are measured by the gap-measuring sensor 42, the controller board 61 determines whether the gap amount of the gaps measured by the gap-measuring sensor 42 is within the reference allowable-gap amount indicated in Table 1 (step S13). At this time, the controller board 61 compares the reference allowable-gap amount corresponding to the type of the platen determined in step S11 among the reference allowable-gap amounts indicated in Table 1 with the gap amount of the gaps measured by the gap-measuring sensor 42.

When the gap amount measured by the gap-measuring sensor 42 is within the reference allowable-gap amount indicated in Table 1, the controller board 61 sets the reference allowable-gap amount indicated in Table 1 as the allowable-gap amount to allow printing to be performed (step S14). The controller board 61 stores the set allowable-gap amount in the storage unit.

Alternatively, when the gap amount of the gaps measured by the gap-measuring sensor 42 is not within the reference allowable-gap amount indicated in Table 1, the controller board 61 determines whether the gap amount of the measured gaps is within a predetermined gap amount. Specifically, the controller board 61 determines whether the gap amount of the gaps measured by the gap-measuring sensor 42 is within the amount obtained by adding the reference allowable-gap amount and the allowable-gap additional amount indicated in Table 1 (step S15).

When the gap amount measured by the gap-measuring sensor 42 is not within the amount obtained by adding the reference allowable-gap amount and the allowable-gap additional amount indicated in Table 1, the controller board 61 records that the setting of the allowable-gap amount has failed (step S16). At this time, the controller board 61 displays a message on the operation panel 52 indicating that the setting of the allowable-gap amount has failed.

If the gap amount of the gaps measured by the gap-measuring sensor 42 is within the amount obtained by adding the reference allowable-gap amount and the allowable-gap additional amount indicated in Table 1, the controller board 61 displays an alert and a query on the operation panel 52 (step S17). In this case, the gap amount of the gaps measured by the gap-measuring sensor 42 is not within the reference allowable-gap amount indicated in Table 1. Accordingly, there is an area in which the gaps between the nozzle surfaces of the recording heads 12 and the recording surface of the recording medium 2 is too large. Accordingly, the landing positions of ink droplets discharged from the recording heads 12 may be shifted to affect an image to be formed, or the distance between the recording heads 12 and the landing positions of the ink droplets may be large, causing the amount of ink mist generated to be increased. For this reason, the controller board 61 displays a message on the operation panel 52 about a risk that an abnormality may occur to an image to be printed and the accuracy in printing may decrease. At this time, a message that inquires whether such a risk as described above is permitted is displayed on the operation panel 52.

When an instruction that allows such a risk is given via the operation panel 52 (step S18), the controller board 61 sets the amount obtained by adding the reference allowable-gap amount and the allowable-gap additional amount indicated in Table 1 as the allowable-gap amount to allow printing to be performed (step S19). The controller board 61 stores the set allowable-gap amount in the storage unit.

Alternatively, when an instruction that does not allow such a risk is given via the operation panel 52, the procedure proceeds to step S16, and the controller board 61 records that the setting of the allowable gap has failed.

As described above, the controller board 61 sets the allowable gap in which printing is allowed.

### Printing Process

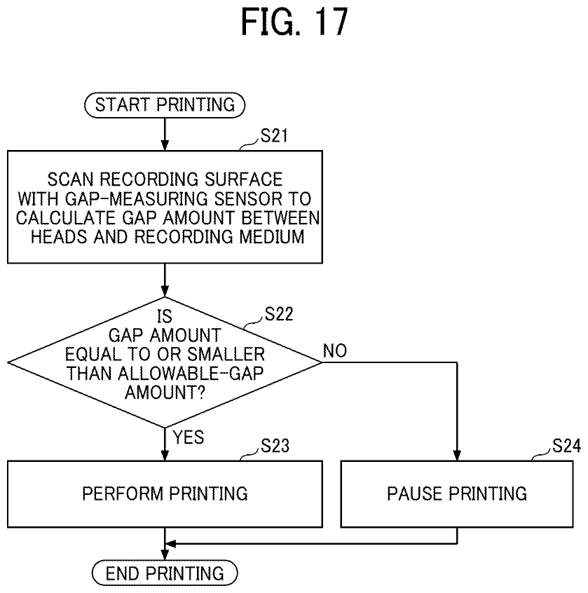

FIG. 17 is a flow chart of a printing process according to the first embodiment.

When the setting of the allowable-gap amount is successful in the above-described procedure, the controller board 61 performs printing on a recording medium set on the platen.

First, when the recording medium is set on the platen 30, the gap-measuring sensor 42 scans the recording surface of the recording medium to measure the gaps between the recording heads 12 and the recording surface of the recording medium. Accordingly, the gap amount is calculated (step S21). The gap amount is calculated using the measured gaps in a similar manner to the processing in step S12. The gap-measuring sensor 42 scans under the control of the controller board 61. When the printing process is continued from the processing illustrated in FIG. 12, the processing in step S21 may be omitted. The setting of the printer 100 may be changed immediately before the printing process is performed. For this reason, the process illustrated in FIG. 12 may be performed immediately before the printing process is performed.

When the gap-measuring sensor 42 calculates the gap amount, the controller board 61 determines whether the calculated gap amount is within the allowable-gap amount set in step S14 or step S19 (step S22).

When the calculated gap amount is within the allowable-gap amount set in step S14 or step S19, the controller board 61 causes the printer 100 to perform printing after the controller board 61 causes the platen lifting mechanism 32 to adjust the height of the platen 30 (step S23). As described above, the gap-measuring sensor 42 measures the gaps between the recording heads 12 and the recording surface of the recording medium. Accordingly, the controller board 61 adjusts the height of the platen 30 such that the maximum height of the recording surface of the recording medium does not contact the recording heads 12 at the maximum height of the recording surface and the minimum height of the recording surface of the recording medium is a height at which printing is allowable in accordance with the allowable-gap amount. The height of the platen may be manually adjusted.

Alternatively, when the calculated gap amount is not within the allowable-gap amount set in step S14 or step S19, the controller board 61 stops printing (step S24). In this case, preferably, the controller board 61 displays an alert on the operation panel 52.

As described above, the allowable-gap amount to be used for determining whether printing is allowable is set to the allowable-gap amount for the recording medium 2 having irregularities when the platen 130 for hat or the platen 330 for shoes is set. When the standard platen is set, the allowable-gap amount for the standard platen is set. In other words, in the present embodiment, the allowable-gap amount is set in accordance with the type of recording medium. Accordingly, when printing is performed on a recording medium having a flat surface, the appropriate allowable-gap amount can be set without unnecessarily increasing the allowable-gap amount. As a result, the generation of ink mist and the deviation of landing positions of ink droplets can be minimized. As a result, such a configuration as described above can prevent the printing accuracy from being decreased when the allowable gap is not set appropriately due to the gap amount of the gaps between the recording heads and the recording surface of the recording medium regardless of the type of the recording medium. Accordingly, printing quality can be enhanced.

In the present embodiment, the reference allowable-gap amount is set for each type of platen prepared in accordance with the type of recording medium, and the type of recording medium is determined using the data indicating the type of platen. As a result, the above-described effect can be obtained only by setting the platen corresponding to the type of the recording medium on the platen setter 31.

### Second Embodiment

In the first embodiment, the type of the recording medium is specified and determined using data indicating the type of platen prepared according to the type of recording medium. However, in a second embodiment, the type of recording medium may be specified and determined using data indicating the type of recording medium itself.

As indicated in Table 2, in the present embodiment, a gap amount, in which printing is allowable, between the recording heads 12 and a recording medium is set as a reference allowable-gap amount for each type of the recording medium. In similar to the first embodiment, in the second embodiment, the allowable-gap additional amount that is used when setting the allowable-gap amount is set. The data indicated in Table 2 may be set on the printer 100 via the operation panel 52 or may be transmitted from a data processing apparatus such as a personal computer connected to the printer 100. The data obtained as described above is stored as a data table in the storage unit of the controller board 61.

TABLE 2

| | Type of recording medium | | | |
|---|---|---|---|---|
| | T-shirts | T-shirts | | |
| | (Thin) | (Thick) | Hoodie | Hat |
| Reference allowable-gap amount | 2 | 3 | 4 | 4 |
| (mm) | | | | |
| Allowable-gap amount (mm) | 1 | 1 | 1 | 2 |

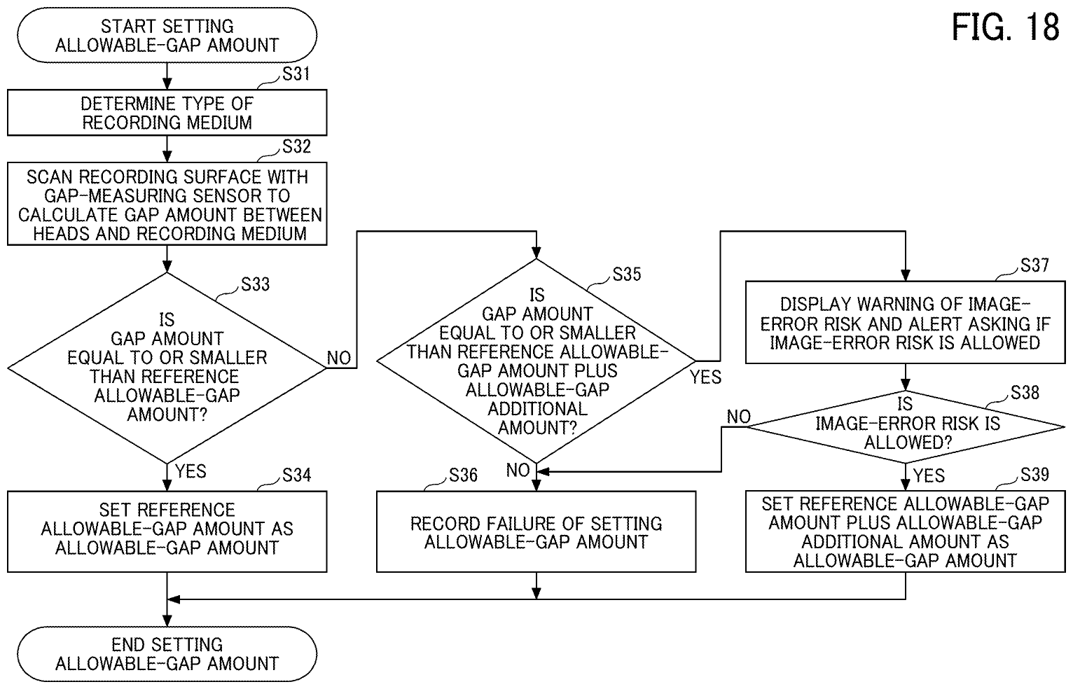

FIG. 18 is a flow chart of a procedure of setting the allowable-gap amount, according to the second embodiment.

First, the type of recording medium for which the allowable-gap amount is to be set is determined (step S31). At this time, numerical values or character string data may be employed as data indicating the type of recording medium itself. The type of recording medium may be determined using data indicating a printing area of the recording medium. Data indicating the type of recording medium itself may also be included in the print data. By so doing, the controller board 61 determines the type of recording medium for which the allowable-gap amount is set.

Subsequently, processing similar to the processing in steps S12, S13, S14, S15, S16, S17, S18, and S19 described in FIG. 12 is performed in steps S32, S33, S34, S35, S36, S37, S38, and S39, respectively, to set the allowable-gap amount.

It is also useful to determine whether printing can be performed based on whether the type of recording medium matches the type of platen. In this case, the type of platen is determined by the methods described in the first embodiment, and the type of recording medium is determined by the methods described in the present embodiment. For example, when the standard platen is set in the printer 100 and the type of recording medium is determined to be a hoodie cloth, printing is performed. However, when the type of recording medium is determined to be a hat, printing may be stopped and an alert may be displayed on the operation panel 52. Such a configuration as described above can prevent erroneous printing from being performed.

Also in the present embodiment, the allowable-gap amount is set in accordance with the type of recording medium. Accordingly, when printing is performed on a recording medium having a flat surface, the appropriate allowable-gap amount can be set without unnecessarily increasing the allowable-gap amount. As a result, the generation of ink mist and the deviation of landing positions of ink droplets can be minimized.

In addition, the data indicating the type of recording medium itself is included in the print data. By so doing, it is not necessary to input or select information indicating the type of recording medium via the operation panel 52.

### Third Embodiment

In the above-described embodiments, a print mode may be set when ink is discharged from the recording heads 12 in accordance with the gap amount of the gaps measured by the gap-measuring sensor 42.

As indicated in Table 3, in the present embodiment, the intensity of a discharge waveform and the size of ink droplets are set as a print mode when ink is discharged from the recording heads 12 in accordance with the gap amount of the gaps measured by the gap-measuring sensor 42. In the present embodiment, the intensity of the discharge waveform can be controlled by a voltage value applied from the controller board 61 to the recording heads 12 to discharge ink from the recording heads 12. Increasing the intensity of the discharge waveform can increase the size of ink droplets to be landed on a recording medium.

The data indicated in Table 3 may be set on the printer 100 via the operation panel 52 or may be transmitted from a data processing apparatus such as a personal computer connected to the printer 100. The data obtained as described above is stored as a data table in the storage unit of the controller board 61.

TABLE 3

| Print mode | Discharge waveform | Size of ink droplets |
|---|---|---|
| Normal gap mode | Standard | Standard |
| Large gap mode | Strong | Large |

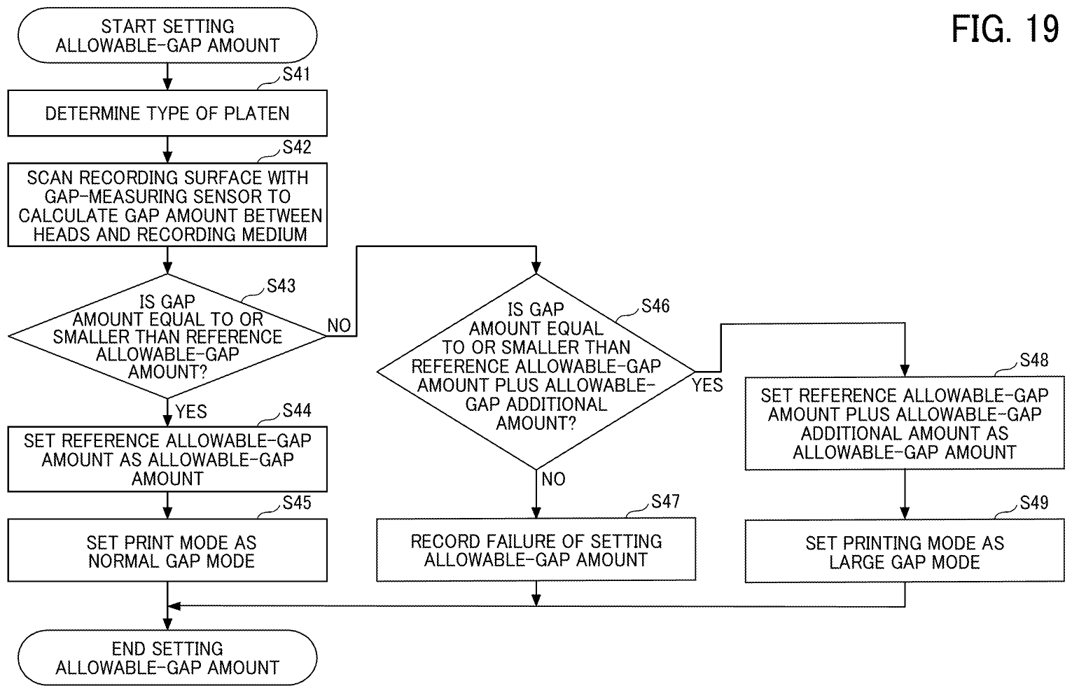

FIG. 19 is a flow chart of a procedure of setting the allowable-gap amount, according to a third embodiment of the present disclosure.

First, processing similar to the processing in steps S11, S12, S13, and S14 described in FIG. 12 is performed in steps S41, S42, S43, and S44, respectively. When the gap amount of the gaps measured by the gap-measuring sensor 42 is within the reference allowable-gap amount indicated in Table 1, the controller board 61 sets the reference allowable-gap amount indicated in Table 1 as the allowable-gap amount in which printing is allowed.

Subsequently, the controller board 61 refers to the data indicated in Table 3 and sets the print mode when ink is discharged from the recording heads 12 as a normal gap mode (step S45). As indicated in Table 3, in the print mode set as the normal gap mode, the intensity of the discharge waveform and the size of the ink droplets are set as standard.

Alternatively, when the gap amount of the gaps measured by the gap-measuring sensor 42 is not within the reference allowable-gap amount indicated in Table 1, the controller board 61 determines whether the gap amount of the gaps measured by the gap-measuring sensor 42 is within a predetermined gap amount. Specifically, the controller board 61 determines whether the gap amount of the gaps measured by the gap-measuring sensor 42 is within the amount obtained by adding the reference allowable-gap amount and the allowable-gap additional amount indicated in Table 1 (step S46).

When the gap amount of the gaps measured by the gap-measuring sensor 42 is not within the amount obtained by adding the reference allowable-gap amount and the allowable-gap additional amount indicated in Table 1, the controller board 61 records that the setting of the allowable-gap amount has failed (step S47). At this time, the controller board 61 displays a message on the operation panel 52 indicating that the setting of the allowable-gap amount has failed.

Alternatively, when the gap amount of the gaps measured by the gap-measuring sensor 42 is within the amount obtained by adding the reference allowable-gap amount and the allowable-gap additional amount indicated in Table 1, the controller board 61 sets the amount obtained by adding the gap amount of the gaps measured by the gap-measuring sensor 42 and the allowable-gap additional amount as the allowable-gap amount. Specifically, the controller board 61 sets the amount obtained by adding the reference allowable-gap amount and the allowable-gap additional amount indicated in Table 1 as the allowable-gap amount in which printing is allowed (step S48). The controller board 61 stores the set allowable-gap amount in the storage unit.

Subsequently, the controller board 61 refers to the data indicated in Table 3 and sets the print mode when ink is discharged from the recording heads 12 to the large gap mode (step S49). As indicated in Table 3, in the print mode set as the large gap mode, the intensity of the discharge waveform is increased and the size of ink droplets is large. The intensity of the discharge waveform can be increased by increasing the voltage value applied from the controller board 61 to the recording heads 12 to cause the recording heads 12 to discharge ink as compared with the case in which the intensity of the discharge waveform is set as standard. The size of ink droplets can be increased by increasing the intensity of the discharge waveform as compared with the case in which the size of ink droplets is set as standard.

As described above, the controller board 61 sets the allowable gap in which printing is allowed.

As described above, in the present embodiment, the intensity of the discharge waveform and the size of ink droplets when ink is discharged from the recording heads 12 are set as the print mode in accordance with the gap amount of the gaps measured by the gap-measuring sensor 42. Specifically, when the gap amount of the gaps measured by the gap-measuring sensor 42 is large, the intensity of the discharge waveform when ink is discharged from the recording heads 12 is increased to increase the size of ink droplets. Accordingly, even when the gap amount of the gaps measured by the gap-measuring sensor 42 is large, ink droplets can be landed in a relatively stable manner onto an area of a recording medium in which the gaps between the recording medium and the recording heads 12 are large. Accordingly, decrease in printing accuracy can be prevented.

### Fourth Embodiment

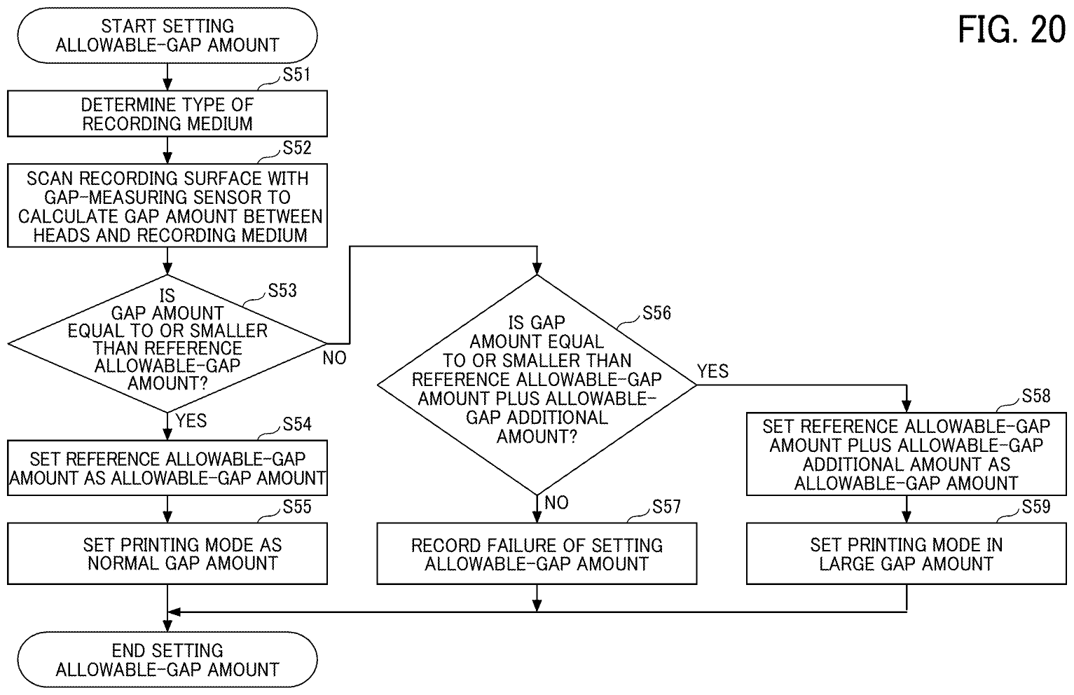

FIG. 20 is a flow chart of a procedure of setting the allowable-gap amount, according to a fourth embodiment of the present disclosure.

First, similar to the processing (step S31) in FIG. 18, the type of recording medium for which the allowable-gap amount is to be set is determined (step S51).

Subsequently, processing similar to the processing in steps S42, S43, S44, S45, S46, S47, S48, and S49 described in FIG. 19 is performed in steps S52, S53, S54, S55, S56, S57, S58, and S59, respectively, to set the allowable-gap amount.

As described above, also in the present embodiment, the intensity of the discharge waveform and the size of ink droplets when ink is discharged from the recording heads 12 are set as the print mode in accordance with the gap amount of the gaps measured by the gap-measuring sensor 42. Accordingly, even when the gap amount of the gaps measured by the gap-measuring sensor 42 is large, ink droplets can be landed in a relatively stable manner onto an area of a recording medium in which the gaps between the recording medium and the recording heads 12 are large. Accordingly, decrease in printing accuracy can be prevented.

Note that, for example, the configurations according to the above-described embodiments of the present disclosure may be combined with other components, and the embodiments of the present disclosure are not limited to the above-described configurations. Any one of the above-described configurations may be modified in various other ways without departing from the gist of the present disclosure and can be appropriately determined according to the application form.

Aspects of the present disclosure are, for example, as follows.

### First Aspect

A liquid discharge apparatus includes a recording head, a platen to hold a recording medium, a measuring device to measure a gap between the recording head and a recording surface of the recording medium held by the platen, and a controller to cause the recording head to discharge liquid droplets in accordance with print data to perform printing on the recording medium held on the platen. The controller sets an allowable range of the gap between the recording head and the recording surface of the recording medium, in which printing is allowed for a type of the recording medium, in accordance with data for specifying the type of the recording medium held by the platen and a measured value of the gap measured by the measuring device.

### Second Aspect

In the liquid discharge apparatus according to the first aspect, the platen is prepared in accordance with the type of the recording medium. The controller sets the range of the gap in accordance with data indicating a type of the platen and the measured value of the gap measured by the measuring device.

### Third Aspect

The liquid discharge apparatus according to the first aspect further includes a platen sensor to detect the type of the platen and notify the controller of the type of the platen. The controller sets the range of the gap in accordance with the type of the platen notified from the platen sensor and the measured value of the gap measured by the measuring device.

### Fourth Aspect

In the liquid discharge apparatus according to the first aspect, the controller sets the range of the gap in accordance with the data indicating the type of the recording medium and the measured value of the gap measured by the measuring device.

### Fifth Aspect

In the liquid discharge apparatus according to the fourth aspect, the data indicating the type of the recording medium is included in the print data. The controller sets the range of the gap in accordance with the data indicating the type of the recording medium, which is included in the print data, and the measured value of the gap measured by the measuring device.

### Sixth Aspect

In the liquid discharge apparatus according to any one of the first to fifth aspects, the controller sets a print mode when liquid droplets are discharged from the recording head, in accordance with the data for specifying the type of the recording medium and the measured value of the gap measured by the measuring device.

### Seventh Aspect

In the liquid discharge apparatus according to any one of the first to sixth aspects, the measuring device scans the platen along a designated route to measure the gap between the recording head and the recording surface of the recording medium held by the platen.

### Eighth Aspect

In the liquid discharge apparatus according to any one of the first to seventh aspects, the measuring device scans the platen in accordance with the type of the recording medium to measure the gap between the recording head and the recording surface of the recording medium held by the platen.

### Ninth Aspect

In the liquid discharge apparatus according to any one of the first to eighth aspects, the measuring device measures the gap between the recording surface of the recording medium and the recording head in a non-contact manner with respect to the recording medium held by the platen.

### Tenth Aspect

There is provided a method to be performed in a liquid discharge apparatus including a recording head to discharge liquid droplets, a platen to hold a recording medium, and a controller to cause the recording head to discharge liquid droplets in accordance with print data to perform printing on the recording medium held by the platen. The method is of setting a range of a gap between the recording head and a recording surface of the recording medium, in which printing is allowed for a type of the recording medium, in accordance with data for specifying a type of the recording medium held by the platen and a measured value of the gap measured by a measuring device, the method of setting includes measuring and setting. The method includes measuring the gap between the recording head and the recording surface of the recording medium held by the platen and setting the range of the gap between the recording head and the recording surface of the recording medium, in which printing is allowed for the type of the recording medium, in accordance with the data for specifying the type of the recording medium and the measured value of the gap measured by the measuring device.

The above-described embodiments are illustrative and do not limit the present disclosure. Thus, numerous additional modifications and variations are possible in light of the above teachings. For example, elements and/or features of different illustrative embodiments may be combined with each other and/or substituted for each other within the scope of the present disclosure.

1. A liquid discharge apparatus comprising:
a recording head to discharge liquid droplets;
a platen to hold a recording medium;
a measuring device to measure a gap between the recording head and a recording surface of the recording medium held by the platen; and
control circuitry configured to cause the recording head to discharge liquid droplets in accordance with print data to perform printing on the recording medium held by the platen, the control circuitry configured to set a range of the gap between the recording head and the recording surface of the recording medium, in which printing is allowed for a type of the recording medium, in accordance with data for specifying the type of the recording medium held by the platen and a measured value of the gap measured by the measuring device.

2. The liquid discharge apparatus according to claim 1,
wherein the platen is prepared in accordance with the type of the recording medium, and
wherein the control circuitry is configured to set the range of the gap in accordance with data indicating a type of the platen and the measured value of the gap measured by the measuring device.

3. The liquid discharge apparatus according to claim 2, further comprising a platen sensor to detect the type of the platen and notify the control circuitry of the type of the platen,
wherein the control circuitry is configured to set the range of the gap in accordance with the type of the platen notified from the platen sensor and the measured value of the gap measured by the measuring device.

4. The liquid discharge apparatus according to claim 1,
wherein the control circuitry is configured to set the range of the gap in accordance with data indicating the type of the recording medium and the measured value of the gap measured by the measuring device.

5. The liquid discharge apparatus according to claim 4,
wherein the data indicating the type of the recording medium is included in the print data, and
wherein the control circuitry is configured to set the range of the gap in accordance with the data indicating the type of the recording medium included in the print data and the measured value of the gap measured by the measuring device.

6. The liquid discharge apparatus according to claim 1,
wherein the control circuitry is configured to set a print mode when liquid droplets are discharged from the recording head in accordance with the data for specifying the type of the recording medium and the measured value of the gap measured by the measuring device.

7. The liquid discharge apparatus according to claim 1,
wherein the measuring device is to scan the platen along a designated route to measure the gap between the recording head and the recording surface of the recording medium held by the platen.

8. The liquid discharge apparatus according to claim 1,
wherein the measuring device is to scan the platen in accordance with the type of the recording medium to measure the gap between the recording head and the recording surface of the recording medium held by the platen.

9. The liquid discharge apparatus according to claim 1,
wherein the measuring device is to measure the gap between the recording head and the recording surface of the recording medium in a non-contact manner with respect to the recording medium held by the platen.

10. A method of setting an allowable gap range in a liquid discharge apparatus including a recording head, a platen to hold a recording medium, and control circuitry to cause the recording head to discharge liquid droplets in accordance with print data to perform printing on the recording medium held by the platen, the method comprising:
measuring a gap between the recording head and a recording surface of the recording medium held by the platen; and
setting a range of the gap between the recording head and the recording surface of the recording medium held by the platen, in which printing is allowed for a type of the recording medium, in accordance with data for specifying the type of the recording medium and a measured value of the gap measured by the measuring.
